(19) United States
(12) Patent Application Publication
(10) Pub. No.: US 2025/0382911 A1
(43) Pub. Date: Dec. 18, 2025

(54) INTERNAL COMBUSTION ENGINE WITH HYDROGEN DIRECT INJECTION

(71) Applicant: Dumarey Automotive Italia S.p.A., Torino (IT)

(72) Inventors: Francesco Concetto Pesce, Torino (IT); Alberto Lorenzo Vassallo, Torino (IT); Walter Biasin, Torino (IT); Andrea Coltella, Torino (IT); Riccardo Rossi, Torino (IT)

(73) Assignee: Dumarey Automotive Italia S.p.A., Torino (IT)

(21) Appl. No.: 18/877,873

(22) PCT Filed: Jul. 10, 2023
(86) PCT No.: PCT/IB2023/057054

§ 371 Date: Dec. 20, 2024

(30) Foreign Application Priority Data
Jul. 14, 2022 (IT) 102022000014824

(51) Int. Cl. F02B 23/06; F02B 43/10

(52) U.S. Cl. CPC F02B 23/0675; F02B 23/066; F02B 43/10; F02B 2201/04

(57) ABSTRACT

The present invention relates to an internal combustion engine with hydrogen direct injection. The engine derives from a traditional diesel cycle engine but is modified and optimized to be powered by hydrogen. Some main characteristics of the injection, ignition and combustion systems of direct fuel injection engines are modified. In particular: the piston and specifically the combustion chamber, the “lay-out” of the injector and the lay-out of the spark plug. The invention is applicable to various types of engines with different bores, cylinder head arrangement, rotation speeds and type of mission. The components can be customized accordingly, while maintaining the commonalities with the corresponding components of traditional diesel engines.

### BACKGROUND OF THE INVENTION

### 1. Field of the Invention

The present invention relates to an internal combustion engine with hydrogen direct injection.

The engine derives from a traditional diesel cycle engine but is modified and optimized to be powered by hydrogen. According to the invention, some main characteristics of the injection, ignition and combustion systems of direct fuel injection engines are modified. In particular: the piston and specifically the combustion chamber, the “lay-out” of the injector and the lay-out of the spark plug.

### 2. Brief Description of the Prior Art

Motor vehicles typically operate by using an internal combustion engine to convert the energy of a fuel, such as gasoline or diesel, into mechanical energy to drive the motor vehicle and thereby provide motion to the vehicle's wheels. Unfortunately, fossil fuels are expensive and contribute to environmental pollution. Due to these drawbacks, attention has been paid to the problems of reducing fuel consumption and pollutants emitted by automobiles and other highway vehicles.

To alleviate some of these drawbacks, hydrogen-fueled internal combustion engines have been proposed which, however, require particular arrangements to ensure correct operation.

First, near complete combustion of hydrogen is difficult to achieve. To reduce the amount of hydrogen, a good stratification of the charge (air and hydrogen) should be ensured, which requires a redesign of the combustion system.

Furthermore, the ignition of hydrogen is strongly influenced by the air/hydrogen ratio: ignition is difficult at low load, in the case of lean mixtures, while at high loads the opposite effect occurs, i.e., there is unwanted pre-ignition of the mixture. Known combustion systems are not efficient for solving this problem as well.

There is therefore the need to define an innovative internal combustion engine with hydrogen direct injection which is free from or at least minimizes the above-mentioned drawbacks.

### SUMMARY OF THE INVENTION

In order to substantially solve the technical problems highlighted above, an object of the present invention is to define an internal combustion engine with hydrogen direct injection.

The engine derives from a traditional diesel cycle engine but is modified and optimized to be powered by hydrogen. According to the invention, some main characteristics of the injection, ignition and combustion systems of direct fuel injection engines are modified. In particular: the piston and specifically the combustion chamber, the “layout” of the injector and the lay-out of the spark plug.

The invention is applicable to various types of engines with different bores, cylinder head arrangement, rotation speeds and type of mission. The components can be customized accordingly, while maintaining the commonalities with the corresponding components of traditional diesel engines.

Therefore, according to the present invention there is provided a hydrogen direct injection internal combustion engine having the characteristics set forth in the independent claim, annexed to the present description.

Further embodiments of the invention, preferred and/or particularly advantageous, are described according to the characteristics set forth in the attached dependent claims.

### BRIEF DESCRIPTION OF THE DRAWINGS

The invention will now be described with reference to the attached drawings, which illustrate some non-limiting embodiments, in which:

FIG. 1 is a cross section of a cylinder head (with parts removed for clarity) and the relative piston of an internal combustion engine with hydrogen direct injection according to an embodiment of the present invention,

FIG. 2 is a cross-section, on an enlarged scale, of the cylinder head (with parts removed for clarity) and the piston of FIG. 1, which illustrates the positioning of the injector and the relative spray angle,

FIG. 3 is a cross section, on an enlarged scale, of the piston of FIG. 1 including a combustion chamber, obtained in the crown of the piston itself,

FIG. 4 is a top view of the combustion chamber of FIG. 3,

FIG. 5 is a detail on a further enlarged scale of the cylinder head (with parts removed for clarity) of FIG. 1 which illustrates a characteristic of the injector “lay-out”,

FIG. 6 is a detail on a further enlarged scale of the cylinder head (with parts removed for clarity) of FIG. 1 which illustrates a further characteristic of the “layout” of the injector, and

FIG. 7 is a cross-section, on an enlarged scale, of the cylinder head (with parts removed for clarity) and of the piston of FIG. 1, in which a characteristic of the spark plug is illustrated.

### DETAILED DESCRIPTION OF THE PREFERRED EMBODIMENTS

By way of a purely non-limiting example, the present invention will now be described with reference to the aforementioned figures.

The invention is a hydrogen direct injection internal combustion engine which derives from a traditional direct injection diesel cycle engine but is modified and optimized to be powered by hydrogen.

The internal combustion engine is a volumetric motive machine in which a cycle equivalent to the well-known Diesel cycle takes place. In fact, in the Diesel cycle, a first reactant, essentially made up of air, is introduced into a cylinder in which a piston moves. It is compressed thanks to a closure of the cylinder in which the reactant is contained (a closure that can take place, for example, by closing valves). A volumetric compression ratio is identified as the ratio between the initial volume of the first reactant charge and the final volume at the end of the reduction process of the volume contained in the envelope, R=Vi/Vf. In the absence of the limit imposed by the detonation phenomenon in a Diesel type scheme, the compression ratio can typically be raised in the range of 10-20. A higher compression ratio can correspond to a higher energy efficiency. The compression takes place in a short time so that the heat exchange with the casing is a small fraction of the energy required for the compression. In this way a compression close to an adiabatic transformation is achieved, whereby the temperature at the end of the compression is much higher than the initial one. Around the end of compression point (typically with a certain advance compared to the point itself), a second reactant, hydrocarbon or other fuel, is introduced through a duct called an injector, with a much higher pressure than that of the first reactant contained in the casing, which rapidly mixes with the first reactant. Thanks to the high temperature reached by the first reactant due to the compression, a reaction starts between the two reactants, which leads to the formation of third compounds, with development of the reaction energy. In many machines, the injection of the second reactant takes place in a time-modulated manner, to obtain a good completeness of the reaction. Furthermore, it is possible that more reagents are introduced, for example to overcome the difficulty of triggering the reaction of the reagents (technique adopted, for example, in “dual fuel” engines, in which a fraction of reagent (typically fuel gas) is added to the air introduced into the casing and the start of the oxidation reaction is ensured by the injection, at the end of compression, of a small quantity of liquid fuel with easy ignition characteristics.

This is followed by the expansion inside the casing, with collection of the expansion energy of the high temperature gas resulting from the reaction, and the expulsion of the reaction products, through suitable valves or openings.

What has been described, in the event that the first reactant is air and at least one second reactant is a fuel or in any case a substance which can implement an oxidation reaction by the oxygen present in the air, constitutes the known functioning of a Diesel cycle machine.

According to the invention, the internal combustion engine reproduces what is described and known to those skilled in the art, but has various innovative characteristics.

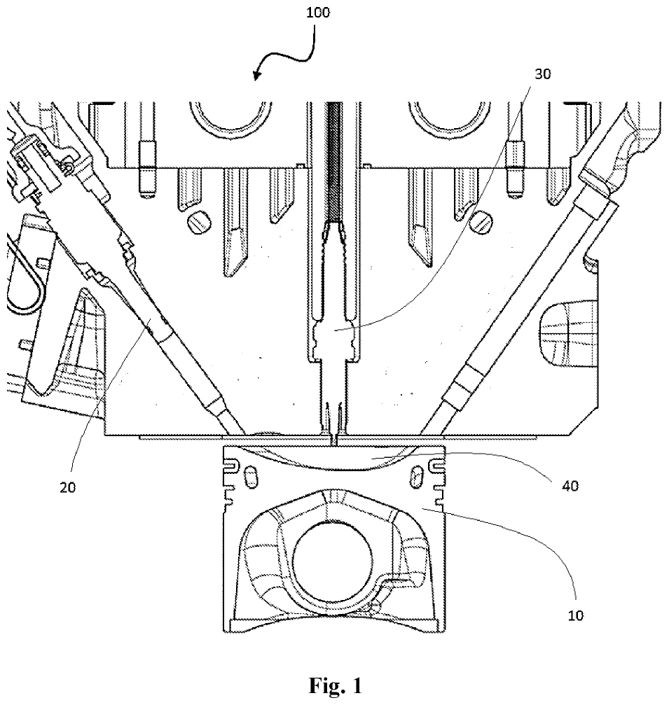

With reference to FIG. 1, 100 indicates a cylinder head and 10 the relative piston of the internal combustion engine with hydrogen direct injection according to the present invention. The main novelty elements concern the combustion chamber, the “lay-out” of the injector 20 and the lay-out of the spark plug 30. In particular, the novelties concern the geometry and the profile of the combustion chamber 40 of the piston and the one corresponding to the arrangement of the injector 20, the injection strategies and the characteristics of the intake system; the “lay-out” and the connection hole 21 of the injector 20 to the combustion chamber 40, in order to promote good stratification of the charge and reduce unburnt hydrogen to a minimum; an optimized protrusion s, heat range, and the “layout” of the spark plug 30 to promote robust ignition at low load while avoiding pre-ignition at high loads. All these characteristics will be better described in the following.

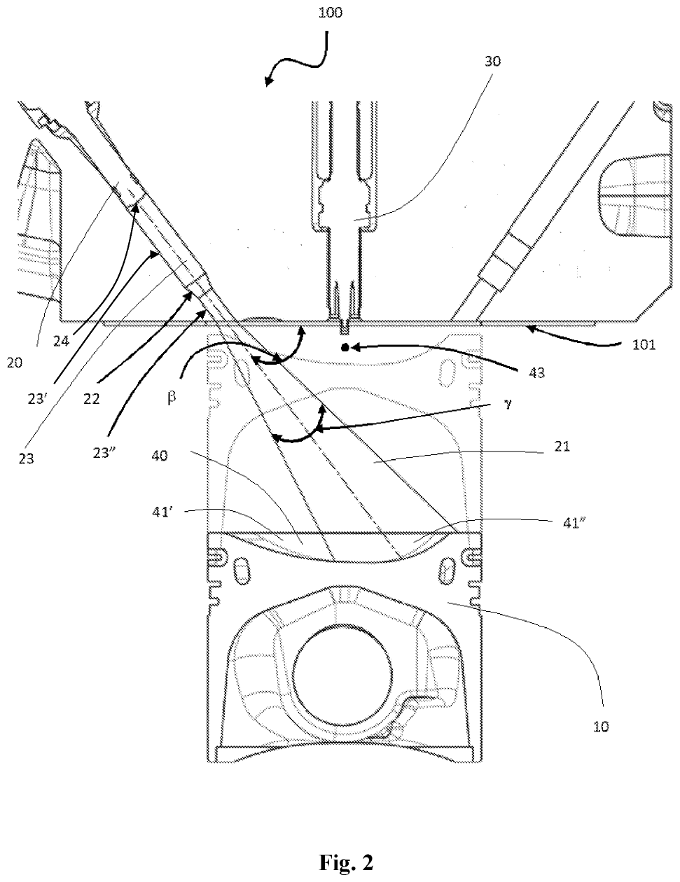

With reference also to FIGS. 2, 3 and 4, the combustion chamber 40 of the piston 10 has an original design with non-symmetrical geometry capable of providing an optimized mixing of injected hydrogen by delayed direct injection, with controllable stratification based on the injection phase and pressure. The chamber profile also provides strength as the level of suction charge swirl, charge density, and injector angle varies. Finally, this profile can easily be made in the semi-finished products of traditional pistons for diesel cycle engines.

The offset of the combustion chamber profile and, in general, its asymmetry is defined to take into account the effective point of impact of the hydrogen spray 21 on the walls of the chamber. The conformation and layout of the spray 21 is a fundamental parameter in the design of the piston, since it is a function of the window of crank angles of the crankshaft within which the injection is typically released.

For low pressure hydrogen direct injection (injection pressure typically between 30 bar and 50 bar), the crank angle is normally between 180° ahead of top dead center (BTDC) and 90°, always BTDC.

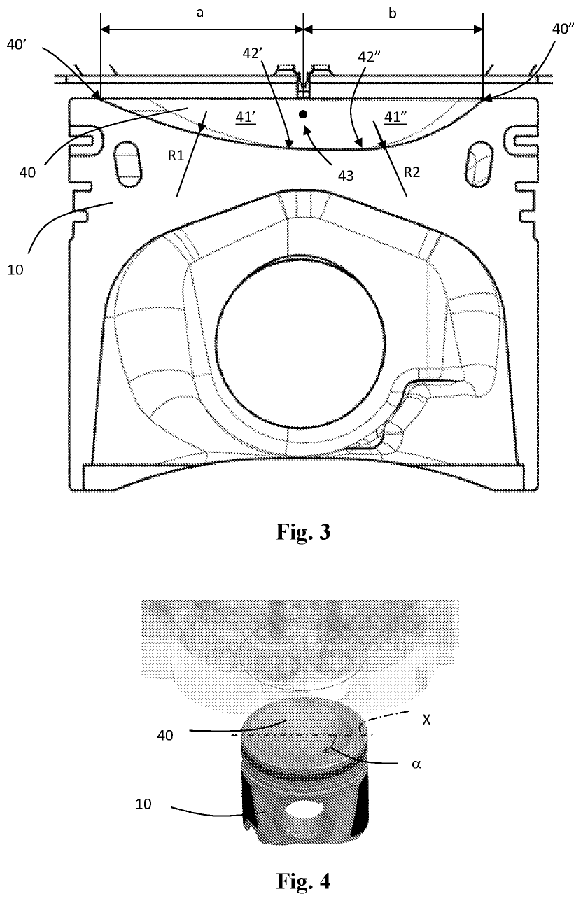

The asymmetry of the combustion chamber 40 is design regulated by some parameters. With respect to a theoretical center 43 of the combustion chamber 40 (in FIGS. 2 and 3 schematized with a dot) in correspondence with the spark plug 30, we define the ends of the combustion chamber 40 with 40′ and 40″. More precisely, a first end 40′, proximal with respect to the injector 20 and a second end 40″, distal with respect to the injector 20.

The asymmetry of the room is regulated by the fact that it will have to turn out

a >b
wherein
a is the distance along an axis X of the chamber between the first end 40′ and the center 43, and
b is the distance along the same axis X between the second end 40″ and the center 43.

Furthermore, with 41′ we define a first portion of the combustion chamber 40 comprised between the first end 40′ and the center 43, therefore proximal with respect to the injector 20 and with 41″ a second portion of the combustion chamber 40 comprised between the second end 40′ and the center 43, therefore distal with respect to the injector 20. The first portion 41′ is less deep than the second portion 41″ and has a bottom wall 42′ whose radius R1 is greater than the radius R2 of the bottom wall 42″ of the second portion 41″.

The substantially deeper asymmetric arrangement of the combustion chamber 40 in the portion 41″ is designed to capture most of the spray 21 and avoid direct impingement on the walls 42′, 42″ of the chamber, as well as to favor better mixing towards the center 43 of the chamber, when the piston is at top dead center (TDC) at the end of the compression stroke and during the ignition stroke of the mixture.

In FIG. 4, top view of the combustion chamber 40, the central axis X of the combustion chamber is rotated around the axis of the piston 10, as a function of the swirl ratio (SR), by an angle □ whose values are preferably between 15° and 45°. This is done to take into account the rotation of the hydrogen spray 21 due to the swirl motion of the air and allow a clear inversion of the spray once it reaches the upper part of the piston 10, i.e., the wall 42″ of the second portion 41″ of the combustion chamber 40. All this also happens due to the fact that a smooth and soft surface has been created on the piston, so as to allow wide variations of the effective destination of the spray depending on the swirl level, charge density, hydrogen injection pressure, the time and duration of the injection itself, as well as the engine operating conditions (in particular, speed and load).

The injector 20 for the direct injection of hydrogen is positioned between the intake ducts (of a known type and therefore not shown in the figure), so as to be on the cold side of the cylinder head 100. The angle of inclination of the injector 20, with respect to a horizontal surface 101 of the cylinder head 100, which defines the ceiling of the combustion chamber 40, is preferably between 40° and 60°, depending on the assembly possibilities, in the case of low-pressure direct injection. The adjustment of the inclination angle □ of the injector 20 serves to avoid the so-called “Coanda effect”, i.e., the tendency of a jet of fluid to follow the contour of a nearby surface, in our case the horizontal surface 101 of the cylinder head 100. Incidentally, in the case of high-pressure direct injection (injection pressure generally between 200 bar and 350 bar) with an injection which is carried out closer to the top dead center, the inclination angle of the injector can be reduced up to 20°.

The opening angle □ of the spray 21 is of reduced amplitude, compared to the prior art, thanks to the converging section 22 of the channel 23 connecting the nozzle 24 of the injector 20 and the combustion chamber 40, which reduces the effective opening angle of the nozzle 24 itself to a minimum.

The amount of hydrogen contained in the channel which connects the injector 20 with the combustion chamber 40 can be “adjusted” to a certain extent by varying the geometry of the connection channel 23 (for example, by adapting the diameter of the nozzle 24 of the injector 20 to the dimensions of the connection channel 23 to control the penetration of the spray and the extinguishing of the flame), the injection pressure and the time window of the injection event.

In particular, the connection channel 23 is provided with a first cylindrical section 23′ proximal to the nozzle 24 of the injector 20 and with a second cylindrical section 23″ distal to the nozzle 24 and in communication with the combustion chamber 40. The two sections of the channel are separated by the converging section 22. The length of the first cylindrical section 23′ can advantageously be between 20 mm and 40 mm, while the length of the second cylindrical section 23″ can be between 5 mm and 15 mm. The diameter of the first cylindrical section 23′ is linked to and is almost equal to the diameter of the nozzle 24, while the diameter of the second cylindrical section 23″ can be between 5 mm and 8 mm.

In this way it is possible to increase or reduce the quantity of hydrogen present in the connection channel 23 and released during the expansion stroke of the piston 10. The quantity of hydrogen released in this phase can be ‘tuned’ to the specific needs of the exhaust gas post-treatment system, where present (for example, to obtain rapid heating using the oxidizing catalyst or to reduce nitrogen oxides using a reducing catalyst of the “Selective catalyst reduction” type).

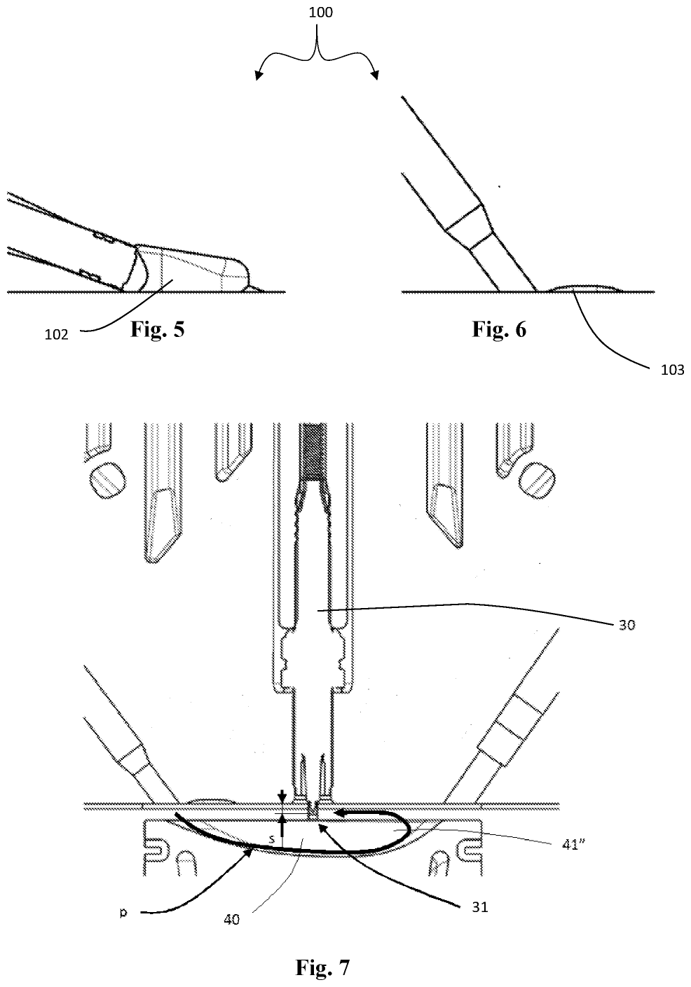

With reference to FIGS. 5 and 6, the cylinder head 100 is provided with a first groove 102 and a second groove 103. These grooves of the cylinder head 100 deflect the spray, improving the detachment of the flow from the cylinder head (in other words, they counteract the establishment of the Coanda effect). The separation of the flow is necessary to favor the mixing of the fuel and to avoid the “floating” of the hydrogen. These characteristics are especially necessary in the case of a small angle of inclination □ of the injector 20, i.e., in the case of direct injection at high pressure.

Finally, FIG. 7 shows the mean path p of the hydrogen spray. As can be seen from the figure, the hydrogen charge travels through the combustion chamber 40 from the proximal end to the connection channel 23 with the injector 20 up to the second portion 41″ opposite to the injector 20 undergoing a sharp rotation and then be redirected towards the electrode 31 of the spark plug 30.

Therefore, the protrusion s of the spark plug 30 from the horizontal surface 101 of the cylinder head 100 must preferably be between 0 mm and 2 mm and in any case balanced with the thermal degree of the plug, in order to avoid pre-ignition phenomena at high powers. The position of its electrode 31 on the four 90° quadrants is an important parameter to facilitate the passage of the charge through the slot of the electrode 31 and should be positioned orthogonally to the axis of the injector 20.

Ultimately, the hydrogen direct injection internal combustion engine, according to the present invention, represents a simple but effective retrofit of existing diesel cycle engines, since only a reworking of the existing cylinder head is required.

Furthermore, it allows hydrogen direct injection both above and below the intake manifold, simply by adapting the outlet of the hydrogen inlet port to the combustion chamber.

Finally, the versatility of this architecture allows it to be adjusted and therefore adapted to direct injection in both low-pressure and high-pressure conditions.

In addition to the form of the invention as described above, it must be understood that there are numerous other variants. It must also be understood that these forms of embodiment are merely illustrative and do not limit either the scope of the invention, its applications or its possible configurations. On the contrary, although the above description allows the skilled person to implement the present invention at least according to one exemplary form of embodiment thereof, it should be understood that many variations of the described components are possible, without thereby departing from the scope of the invention as defined in the appended claims, which are interpreted literally and/or according to their legal equivalents.

1. An internal combustion engine with hydrogen direct injection equipped with:
a cylinder head (100) equipped with at least one injector (20) configured to inject a spray (21) of hydrogen,
at least one piston (10) the engine being characterized by the fact that:
a combustion chamber (40) of the piston (10) has a non-symmetrical geometry with a first portion (41′), proximal to the injector (20) less deep than a second portion (41″), distal to the injector (20), the non-symmetrical geometry having the function of capturing most of the hydrogen spray (21) and avoiding direct impact of the hydrogen spray (21) on the walls (42′, 42″) of the combustion chamber (40), as well as favoring the best mixing towards the center (43) of the combustion chamber (40), and
a connection channel (23) between the injector (20) and the combustion chamber (40) is provided with a converging section (22) configured to reduce an opening angle (Y′) of the hydrogen spray (21).

2. The engine according to claim 1, wherein the projection(s) of the spark plug (30) from a horizontal surface (101) of the cylinder head (100), which defines the top of the combustion chamber (40), is comprised between 0 mm and 2 mm.

3. The engine according to claim 1, wherein:
the distance (a) along a central axis (X) of the combustion chamber (40) between a first end (40′) of the combustion chamber (40), proximal to the injector (20), and the center (43) is greater than the distance (b) along the central axis (X) of the combustion chamber (40) between a second end (40″) of the combustion chamber (40), distal to the injector (20), and the center (43); and
the first portion (41′) of the combustion chamber (40) has a bottom wall (42′) whose radius (R1) is greater than the radius (R2) of the bottom wall (42″) of the second portion (41 “).

4. The engine according to claim 3, in which the central axis (X) of the combustion chamber (40) is rotated around the axis of the piston (10) as a function of the swirl ratio (SR), by an angle (α) whose values are between 15° and 45°.

5. The engine according to claim 1, in which an angle of inclination (β) of the injector (20), with respect to a horizontal surface (101) of the cylinder head (100), is not less than 20°.

6. The engine according to claim 5, in which the angle of inclination (β) of the injector (20) is between 40° and 60°, in the case of direct injection at low pressure.

7. The engine according to claim 1, in which the connecting channel (23) is provided with a first cylindrical section (23′), proximal to the nozzle (24) of the injector (20), and with a second cylindrical section (23”), distal to the nozzle (24) and in communication with the combustion chamber (40), separated by the converging section (22).

8. The engine according to claim 7, in which the first cylindrical section (23′) has a length between 20 mm and 40 mm and a diameter almost equal to the diameter of the nozzle (24).

9. The engine according to claim 7, wherein the second cylindrical section (23″) has a length comprised between 5 mm and 15 mm and a diameter comprised between 5 mm and 8 mm.

10. Engine according to claim 1, wherein the cylinder head (100) is provided with a first groove (102) and a second groove (103) configured to deflect the hydrogen spray (21).
